(19) United States
(12) Patent Application Publication
(10) Pub. No.: US 2005/0145074 A1
(43) Pub. Date: Jul. 7, 2005

(54) Ratchet wrench with removable tool head

(76) Inventor: Tseng Mu Mau, Ta Li City (TW)

Correspondence Address: CHARLES E. BAXLEY, ESQ., 90 JOHN STREET, THIRD FLOOR, NEW YORK, NY, 10038, US

(21) Appl. No.: 10/751,225

(22) Filed: Jan. 2, 2004

(51) Int. Cl. B25B 13/46

(52) U.S. Cl. 81/63

(57) ABSTRACT

A ratchet wrench with a removable tool head comprises a main body, wherein a control piece, control rod, a positioning element, an elastic element and a tool head for positioning are provided. The user may use the control piece to realize left, right or central positioning. The control rod engages with the control piece through a bayonet pin to realize stable operation. A saddle-shaped structure of the control piece corresponds to the positioning element and the elastic element to proceed rotary positioning. Thus, the main body of the present invention may be provided with tool head of different sizes and types and the user can stably position and operate the tool head. And the control rod and the control piece can produce sufficient operating force.

### BACKGROUND OF THE INVENTION

1. Field of the Invention

The present invention relates to a ratchet wrench, and more particularly to a ratchet wrench capable of being provided with tool head of different sizes and types and the user can stably position and operate the tool head.

2. Description of the Prior Arts

The ratchet wrench is one of the commonest hand tools that have been widely applied for a long period, the structures of the ratchet wrenches are much varied. Thereby it is an important object to develop a simple structured ratchet applicable to different sized objects.

Due to a conventional ratchet wrench is only applicable to single sized object (such as screw nut, bolt), thereby in real operation a number of different sized ratchet wrenches are required for ensuring a successful operation, obviously the conventional ratchet wrench lacks of enough applicability.

On the other hand, the control rod of the conventional ratchet wrench is usually fixed to the main body of the wrench by rivets. However, the control rod often bears a lot of rotation stress since the user constantly rotates it, so the conjunction of the rivet is susceptible to broken.

Another problem of the conventional ratchet wrench is: the control unit between the control rod and the ratchet is complicatedly structured, which results in a high cost.

In addition, only one side of the tool head of the conventional ratchet wrench is workable, and another side of the tool head is assembled in the main body of the ratchet wrench, so the applicability is limited.

The present invention has arisen to mitigate and/or obviate the afore-described disadvantages of the conventional ratchet wrench.

### SUMMARY OF THE INVENTION

The primary object of the present invention is to provide a ratchet wrench with a removable tool head capable of fitting tool heads of different sizes, so as to improve the applicability.

The secondary object of the present invention is to provide a ratchet wrench with a removable tool head, wherein a control piece and a control rod can be firmly engaged with each other during operation.

The further object of the present invention is to provide a ratchet wrench with a removable tool head, wherein the control piece of which can be stably positioned at a left, right or central position thereof.

In accordance with one aspect of the present invention there is provided with a ratchet wrench with a removable tool head which comprises a main body, wherein a control piece, control rod, a positioning element, an elastic element and a tool head for positioning are provided. The user may use the control piece to realize left, right or central positioning. The control rod engages with the control piece through a bayonet pin to realize stable operation. A saddle-shaped structure of the control piece corresponds to the positioning element and the elastic element to proceed rotary positioning. Thus, the main body of the present invention may be provided with tool head of different sizes and types and the user can stably position and operate the tool head. And the control rod and the control piece can produce sufficient operating force.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a ratchet wrench in accordance with the present invention;

FIG. 2 is a cross-sectional view of the ratchet wrench in accordance with the present invention;

FIG. 3 is another cross-sectional view of the ratchet wrench in accordance with the present invention;

FIG. 4 is a schematic diagram in accordance with the present invention of illustrating the principle of modifying the ratchet's position;

FIG. 5 is a cross sectional assembly view of the ratchet wrench in accordance with the present invention;

FIG. 6 is an exploded view of a tool head in accordance with another embodiment of the present invention;

FIG. 7 is a cross sectional view of a tool head in accordance with another embodiment of the present invention;

### DETAILED DESCRIPTION OF THE PREFERRED EMBODIMENTS

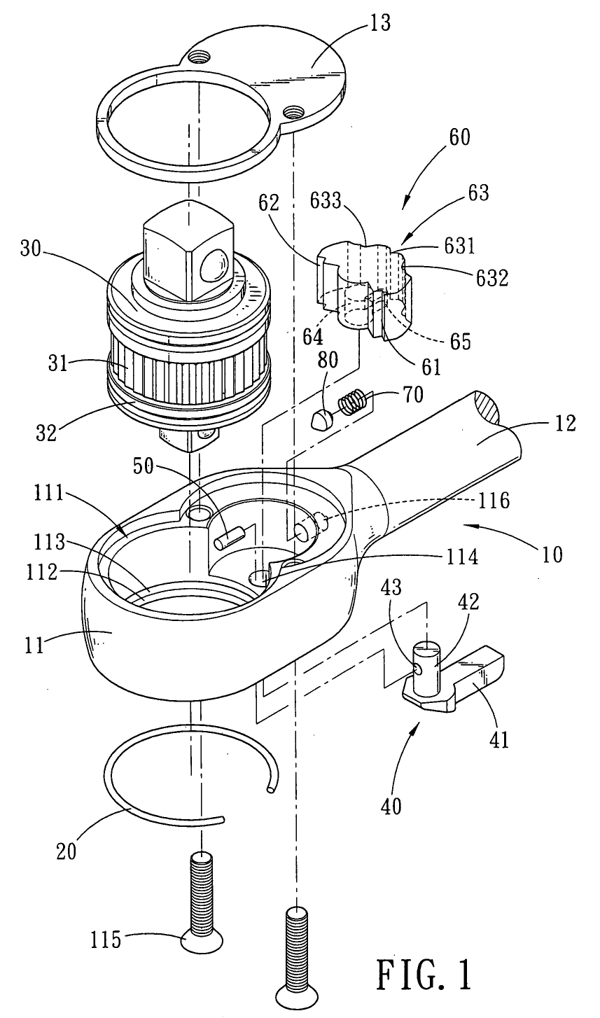

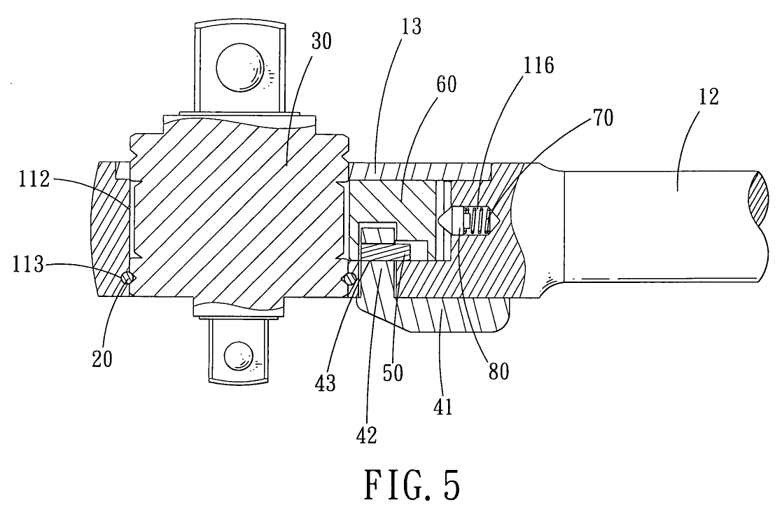

Referring to FIGS. 1, 2 and 5, a ratchet wrench in accordance with the present invention generally comprises a main body 10, a retaining ring 20, a tool head 30, a control rod 40, a bayonet pin 50, a control piece 60, an elastic element 70 and a positioning element 80.

The main body 10 is provided with an integrally formed working head 11 and a handle 12. Wherein the working head 11 is exteriorly formed with a receiving space 111, and a cover 13 is locked on the receiving space 111 through screws 115. In the receiving space 111 is defined with a hole 112, at a side of the hole 112 is formed with an annular groove 113. Furthermore, a control hole 114 is vertically defined in the receiving space 111 and located beside the hole 112, and a horizontal hole 116 is defined on internal surface of the receiving space 111 in corresponding to the control hole 114.

The retaining ring 20 is an elastic ring to be received in the annular groove 113 of the hole 112 of the main body 10 in a manner that the retaining ring 20 protrudes a little out of the internal surface of the hole 112.

The tool head 30 is provided with ratchet teeth 31 on an outer periphery thereof, and an annular flute 32 is defined on the tool head 30 near an end thereof in corresponding to the retaining ring 20. Through the annular flute 32, the tool head 30 can be retained by the retaining ring 20 in the hole 112 of the receiving space 111 of the working head 10. And the tool head 30 also can be disengaged from the retaining ring 20 by an external force.

The control rod 40 includes a poke rod 41 and a shaft 42. An end of the poke rod 41 is vertically connected to the shaft 42. The shaft 42 is inserted in the control hole 114, and a horizontal aperture 43 is defined on the shaft 42 of the control rod 40 and located adjacent to an end thereof.

The bayonet pin 50 is inserted in the horizontal aperture 43 of the control rod 40 in a manner that an end of the bayonet pin 50 protrudes out of shaft 42 of the control rod 40.

The control piece 60 is received in the receiving space 111 of the main body 10 in corresponding to the tool head 30. An aperture 64 is formed on the control piece 60 for the reception of a shaft 42 of the control rod 40, and at a side of the aperture 64 a notch 65 is defined in a horizontal manner for reception of the bayonet pin 50. The control piece 60 is provided at both sides thereof with left tooth 61 and right tooth 62 in corresponding to the ratchet teeth 31 of the tool head 30. The control piece 60 is further provided with a saddle structure 63 in a direction corresponding to the tool head 30, the saddle structure 63 is defined with a middle recess 631 at a center thereof, and at both sides of the middle recess 631 are a left and a right recesses 632, 633. The saddle structure 63 corresponds to the horizontal hole 116 in the receiving space 111 of the main body 10.

The elastic element 70 is disposed in the horizontal hole 116 of the receiving space 111 of the main body 10.

The positioning element 80 is a cylinder with a round end (it also can be a steel ball), an end of which is received in the horizontal hole 116 of the receiving space 111 of the main body 10 in a manner that it pushes against the elastic element 70, whereas the round end of the positioning element 80 engages in the saddle structure 63 of the control piece 60. The positioning element 80 is to be engaged with the saddle structure 63 respectively in the central middle recess 631, left recess 632 and the right recess 633.

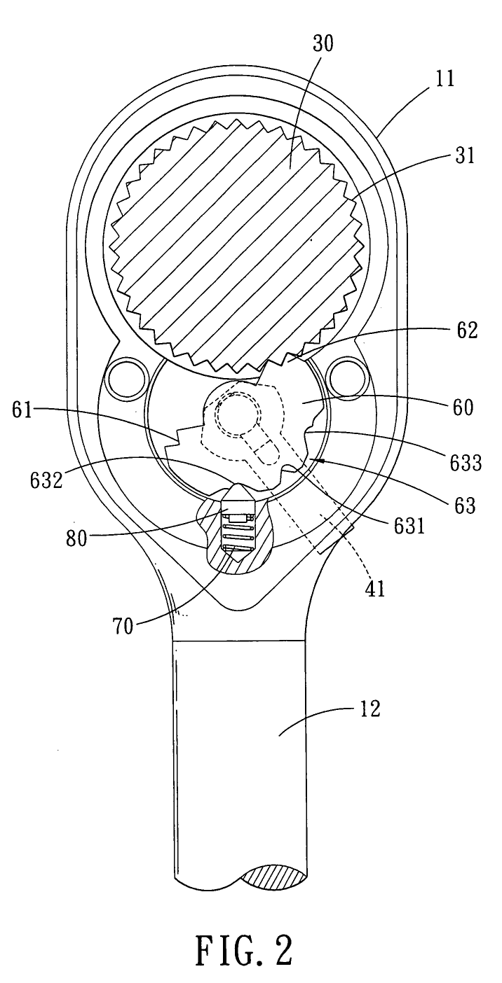

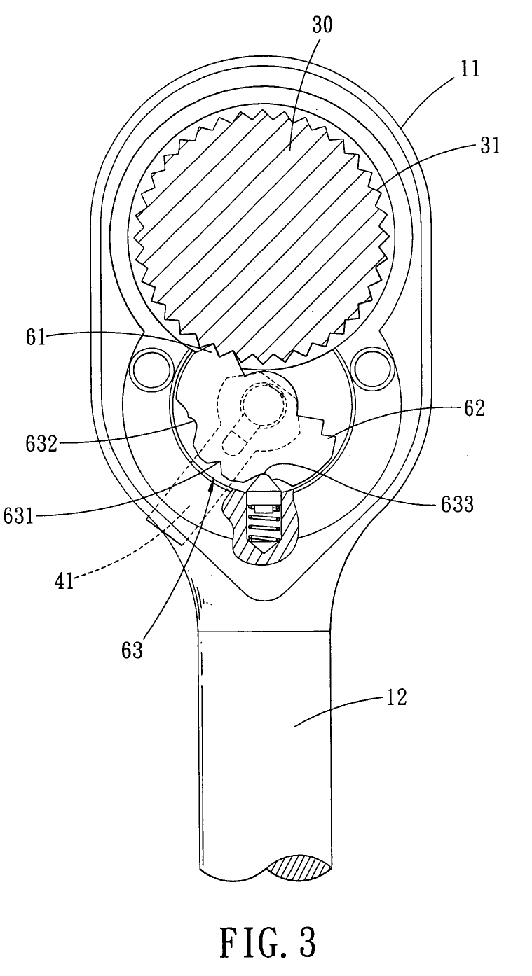

Referring to FIGS. 2 and 3, when the user left and right rotates the poke rod 41 of the control rod 40, the shaft 42 of the control rod 40 and the bayonet pin 50 will drive the control piece 60 to rotate synchronously. And the control piece 60 is positioned by the positioning element 80 in a manner that the control piece 60 slants left or right (the round end of the positioning element 80 engages in the left recess 632 or right recess 633 of the saddle structure 63). The left tooth 61 or the right tooth 62 at both sides of the control piece 60 also will unilaterally engage with the ratchet teeth 31 of the tool head 30, with stable position of the positioning element 80, the present invention is able to rotate unilaterally.

It is to be noted that due to the engagement of the bayonet pin 50 in the notch 65 of the control piece 60, the control 40 and the control piece 60 can more firmly and stably cooperate with each other.

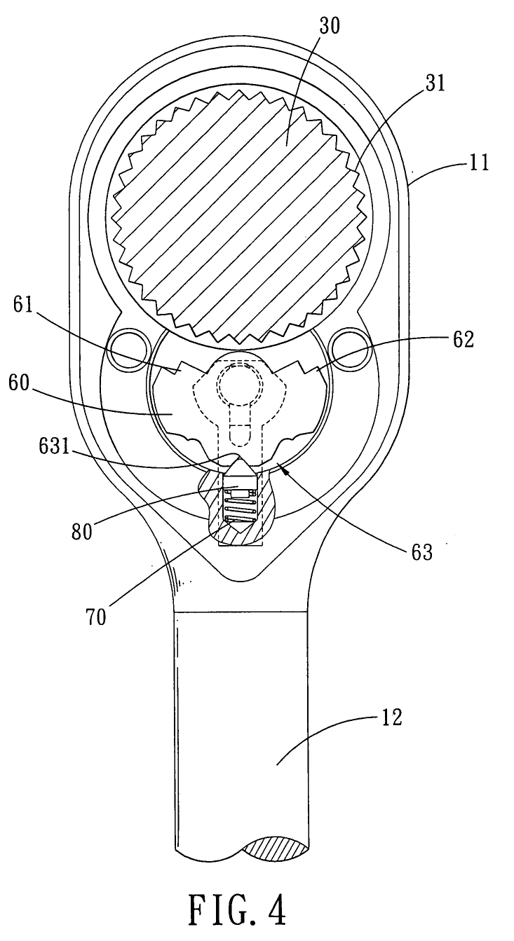

Referring to FIG. 4, when the user rotates the poke rod 41 of the control rod 40 to the center, the shaft 42 of the control rod 40 and the bayonet pin 50 will synchronously drive the control piece 60 to the center.

And the control piece 60 is positioned in the center by the positioning element 80 (the round end of the positioning element 80 engages in the middle recess 631 of the saddle structure 63). At this moment, the left and the right teeth 61, 62 at both sides of the control piece 60 don't engage with the ratchet teeth 31 of the tool head 30, so the user can disengage the tool head 30 from the retaining ring 20 by pushing it with force, and the tool head 30 is then allowed to disengage from the hole 112 of the receiving space 111 of the main body 10 (in assembly, the tool head 30 is positioned by pushing it in inverse direction into the hole 112). Thus, the main body of the present invention may be provided with tool head of different sizes and types and the user can stably position and operate the tool head, and the applicability of the present is improved.

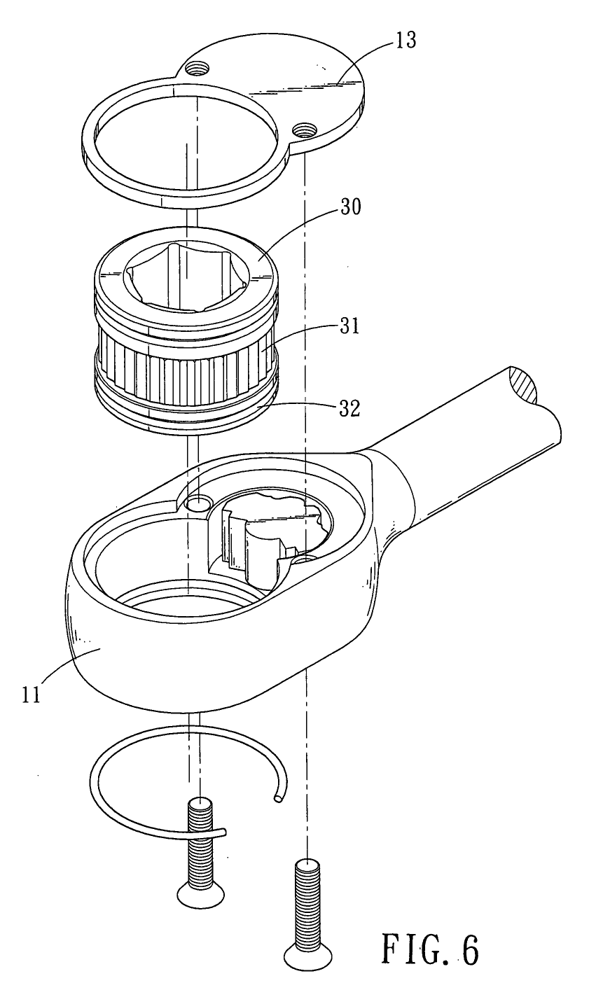

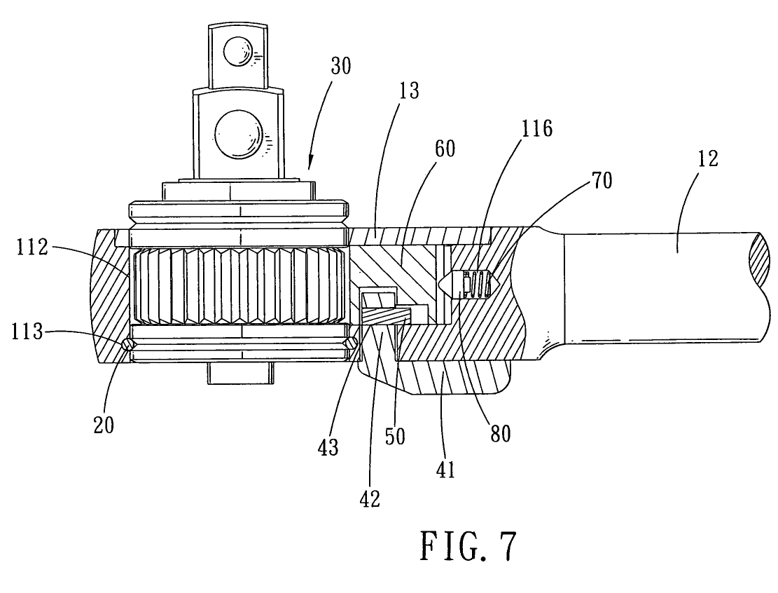

Referring to FIG. 6, which shows a ratchet wrench in accordance with a third embodiment of the present invention, and it can be clearly seen that the tool head 30 is provided with engaging hole for engaging with screw head, so as to realize a screwing/unscrewing operation. It is noted that the tool head 30 is provided with engaging hole or connecting shaft at both sides thereof, thereby the tool at one side of the tool head 30 can be in metric size and another other tool at the other side of the tool head 30 can be in English size, or one tool can be in big size and another tool can be in small size. In addition, with reference to FIG. 7, wherein the tool head 30 also can be in form of stage-shaped connecting shaft. In this way, the applicability of the present is improved.

While we have shown and described various embodiments in accordance with the present invention, it should be clear to those skilled in the art that further embodiments may be made without departing from the scope of the present invention.

1. A ratchet wrench with a removable tool head comprising: a main body, a retaining ring, a tool head, a control rod, a bayonet pin, a control piece, an elastic element and a positioning element;
the main body provided with a receiving space at a head thereof, in the receiving space defined with a hole, at a side of the hole formed with an annular groove, a control hole defined in the receiving space and located beside the hole, and a horizontal hole corresponding to the control hole defined on internal surface of the receiving space;
the retaining ring bring an elastic ring and received in the annular groove of the main body in a manner that the retaining ring protruding a little out of the internal surface of the hole;
the tool head provided with ratchet teeth on an outer periphery thereof, and an annular flute corresponding to the retaining ring defined on the tool head near an end thereof; through the annular flute, the tool head being retained by the retaining ring;
the control rod including an poke rod vertically connected with a shaft, the shaft inserted in the control hole, and a horizontal aperture defined on the shaft of the control rod and located adjacent to an end thereof;
the bayonet pin inserted in the horizontal aperture of the control rod in a manner that an end of the bayonet pin protruding out of shaft of the control rod;
the control piece received in the receiving space of the main body in corresponding to the tool head, an aperture formed on the control piece for reception of the shaft of the control rod, and at a side of the aperture a notch defined in a horizontal manner for reception of the bayonet pin, the control piece provided at both sides thereof with a left tooth and a right tooth in corresponding to the ratchet teeth of the tool head, the control piece further provided with a saddle structure in a direction corresponding to the tool head, the saddle structure defined with a middle recess at a center thereof, and at both sides of the middle recess a left recess and a right recess being defined respectively;
the elastic element disposed in the horizontal hole of the receiving space of the main body;
the positioning element received in the horizontal hole of the receiving space of the main body in a manner that an end of which pushes against the elastic element, and another end of which engages in the saddle structure of the control piece.

2. The ratchet wrench with a removable tool head as claimed in claim 1, wherein the tool head is provided at a surface thereof with engaging hole.

3. The ratchet wrench with a removable tool head as claimed in claim 1, wherein the tool head is provided at its surface with connecting shaft.

4. The ratchet wrench with a removable tool head as claimed in claim 1, wherein the elastic element is spring.
